(19) United States
(12) Patent Application Publication
(10) Pub. No.: US 2011/0119585 A1
(43) Pub. Date: May 19, 2011

(54) APPARATUS AND METHOD FOR PLAYBACK OF FLASH-BASED VIDEO ON MOBILE WEB BROWSER

(75) Inventor: Kyung Jin KIM, Suwon-si (KR)

(73) Assignee: SAMSUNG ELECTRONICS CO. LTD., Suwon-si (KR)

(21) Appl. No.: 12/882,542

(22) Filed: Sep. 15, 2010

(30) Foreign Application Priority Data
Nov. 19, 2009 (KR) 10-2009-0111757

(51) Int. Cl. G06F 3/048

(52) U.S. Cl. 715/719

(57) ABSTRACT

An apparatus and method for playing a flash-based video through a video plug-in on a mobile web browser are provided. The apparatus includes a structure analyzer and a video display controller. The structure analyzer analyzes a structure of flash content. If there is any video information in the analyzed flash content, the structure analyzer extracts the video information from the flash content. The video display controller receives the video information from the structure analyzer, and then controls displaying video according to the received video information by using a video plug-in. This apparatus and method allow effectively playing a flash-based video through a video plug-in even in a case of insufficient system performance.

### PRIORITY

This application claims the benefit under 35 U.S.C. §119(a) of a Korean patent application filed on Nov. 19, 2009 in the Korean Intellectual Property Office and assigned Serial No. 10-2009-0111757, the entire disclosure of which is hereby incorporated by reference.

### BACKGROUND OF THE INVENTION

1. Field of the Invention

The present invention relates generally to video playback technology. More particularly, the present invention relates to an apparatus and method for playing a flash-based video through a video plug-in on a mobile web browser.

2. Description of the Related Art

With wireless communication technologies such as WiFi, Wibro and wireless Local Area Network (LAN) advanced dramatically, together with the popularization of the 3^{rd} generation (3G) mobile communication, mobile devices and embedded devices launched recently on the market are often equipped with a web browser to access and browse information provided by a network.

Normally, because they have lower-level hardware than traditional personal computers have, mobile devices and embedded devices cannot use a typical web browser suitable for personal computers. So, a specific web browser is designed for use on mobile devices or embedded devices and is referred to as a mobile web browser, a full browser, and the like.

However, due to limitations in hardware and software environments of devices, a mobile web browser may often fail to adequately play a flash-based video that is adapted to a normal web page. This is because a flash-based video is composed of a flash video file (in the form of f1v, f4v, H.264, Advanced Video Coding (AVC), etc.) and a player skin (in the combination form of resources such as ActionScript™ based images, sounds, etc. and a control interface such as play, stop, etc.).

Therefore, there is a need for an advanced technology to allow an effective playback of a flash-based video on a mobile web browser used in mobile devices and embedded devices.

### SUMMARY OF THE INVENTION

Accordingly, an aspect of the present invention is to address at least the above-mentioned problems and/or disadvantages and to provide at least the advantages described below.

Accordingly, an aspect of the present invention is to provide an apparatus and method for effectively playing a flash-based video through a video plug-in even in a case of insufficient system performance.

In accordance with an aspect of the present invention, an apparatus for playing a flash-based video is provided. The apparatus includes a structure analyzer configured to analyze a structure of flash content and, if there is any video information in the analyzed flash content, to extract the video information from the flash content. The apparatus further includes a video display controller configured to receive the video information from the structure analyzer and to control displaying video according to the received video information by using a video plug-in.

In accordance with another aspect of the present invention, a method for playing a flash-based video is provided. The method includes analyzing a structure of flash content, if there is any video information in the analyzed flash content, extracting the video information from the flash content, and displaying video according to the video information by using a video plug-in.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a video playback apparatus in accordance with an exemplary embodiment of the present invention.

FIG. 2 is a flow diagram illustrating a video playback method in accordance with an exemplary embodiment of the present invention.

FIG. 3 is an example view illustrating a video playback interface in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following descriptions and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

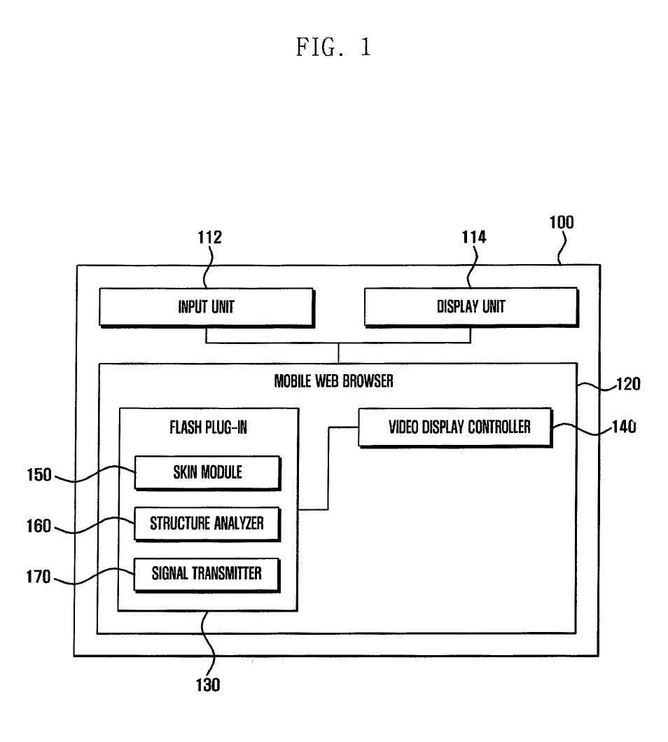

FIG. 1 is a block diagram illustrating a video playback apparatus according to an exemplary embodiment of the present invention.

Referring to FIG. 1, the video playback apparatus 100 according to an embodiment of this invention includes an input unit 112, a display unit 114, and a mobile web browser 120.

This embodiment will be discussed on the assumption that the video playback apparatus 100 is realized in a mobile device. Thus, the video playback apparatus 100 includes the mobile web browser 120. Alternatively, the video playback apparatus 100 may be formed in a personal computer and hence may have a normal web browser instead of the mobile web browser 120. Namely, although being generally a component having a flash plug-in 130 and a video display controller 140, the mobile web browser 120 may be considered as any other component capable of communicating with both the flash plug-in 130 and the video display controller 140.

The mobile web browser 120 is a specific web browser designed for use on the mobile device. More particularly, the mobile web browser 120 has the flash plug-in 130 and the video display controller 140.

A plug-in is an auxiliary program that supports adding new functions to any program. The plug-in itself is not executable, but shows its function when executed in a specific program. Namely, the flash plug-in 130 is a kind of an auxiliary program that supports adding a flash execution function to a web browser. The flash plug-in itself is not executable, but shows a flash execution function when executed in a web browser. Similarly, the video plug-in is a kind of an auxiliary program that supports adding a video playback function to a web browser. The video plug-in itself is not executable, but shows a video playback function when executed in a web browser.

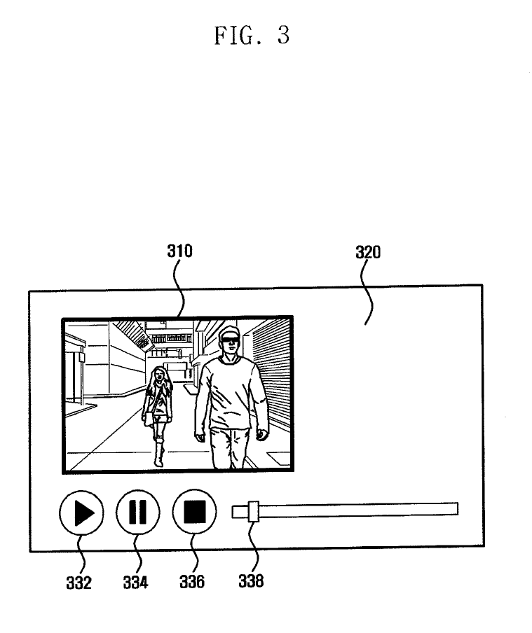

In this disclosure, video information refers to information about a path of flash video content (in the form of f1v, f4v, H.264, Advanced Video Coding (AVC), etc.) or flash video content itself. Additionally, skin information refers to information about a control interface displayed around video content and the like Skin information will be described in more detail below with reference to FIG. 3.

The flash plug-in 130 includes a skin module 150, a structure analyzer 160, and a signal transmitter 170. The structure analyzer 160 analyzes the structure of flash content. If there is any video information in the analyzed flash content, the structure analyzer 160 may extract the video information from the content and send it to the video display controller 140. If there is any skin information in the analyzed flash content, the structure analyzer 160 may extract the skin information from the content and send it to the skin module 150. The skin module 150 receives skin information and displays a skin according to the skin information. The signal transmitter 170 receives an input signal from the input unit 112 and sends a video control signal corresponding to a received input signal to the video display controller 140. The video display controller 140 controls a display of video through a video plug-in according to a received video control signal. Although the signal transmitter 170 usually exists independently of the skin module 150, the signal transmitter 170 may alternatively be combined with the skin module 150. In addition, although the flash plug-in 130 usually contains the skin module 150, the structure analyzer 160 and the signal transmitter 170, they may alternatively be formed independently of the flash plug-in 130.

The video display controller 140 receives video information and controls displaying video according to received video information by using a video plug-in. If video information indicates a path of flash video content, the video display controller 140 receives and displays video content downloaded through the indicated path by using a video plug-in. This video plug-in is an element of the video display controller 140 and can perform specific functions of the video display controller 140. Namely, the video plug-in may receive video information and display video according to received video information. In addition, if video information indicates a path of flash video content, the video plug-in may receive and display video content downloaded through the path.

The input unit 112 receives a user's input manipulation, thereby creates an input signal, and sends the input signal to the mobile web browser 120. The input unit 112 may include at least one of a keypad, a touch screen, a keyboard, a mouse, a trackball, and any other pointing devices or input devices.

The display unit 114 represents a variety of information on a screen in response to an output signal of the mobile web browser 120. The display unit 114 may be formed of a Liquid Crystal Display (LCD), an Organic Light Emitting Device (OLED), or any other equivalents.

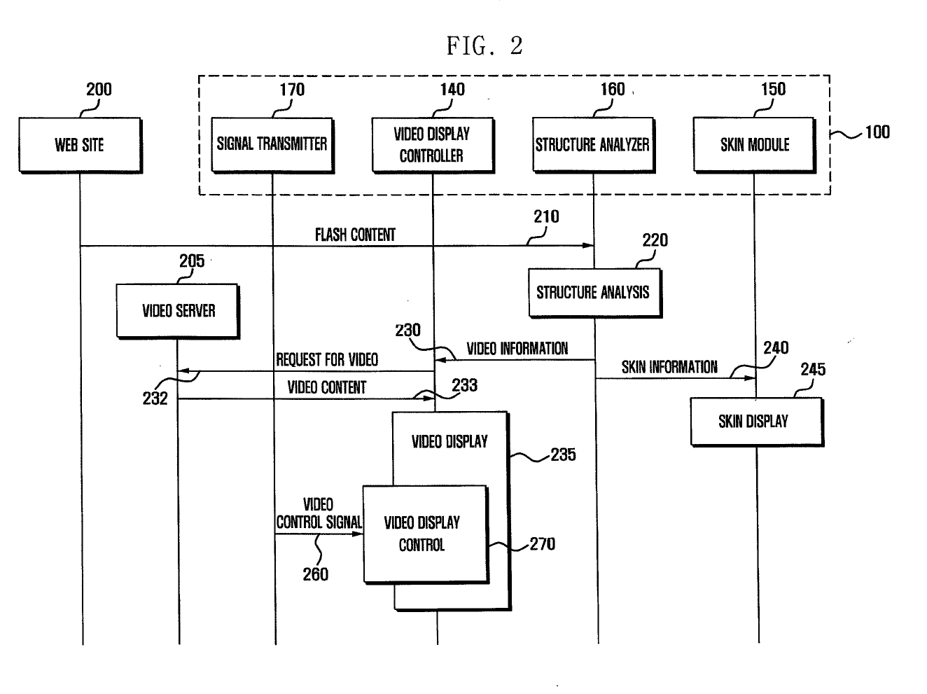

The respective elements in FIG. 1 will be understood much better from the following description with reference to FIGS. 2 and 3.

FIG. 2 is a flow diagram illustrating a video playback method according to an exemplary embodiment of the present invention.

Referring to FIG. 2, the structure analyzer 160 receives certain flash content from a web site 200 in step 210. Flash content is supposed herein to have video information and skin information even though it may have various other forms. If flash content has no video information, the flash plug-in 130 may handle flash content on its own or in cooperation with other elements.

FIG. 3 is an example view illustrating a video playback interface according to an exemplary embodiment of the present invention.

Referring to FIG. 3, the video playback interface includes a video display part 310 and a skin part 320. More particularly, the skin part 320 may contain a control interface such as a play button 332, a pause button 334, a stop button 336, and a slider or progress bar 338. In addition, the skin part 320 may further contain links (e.g., a related video link), logo images, or information (e.g., a file name, a video title, etc.) about video displayed on the video display part 310. What is displayed on the video display part 310 depends on video information, and what is displayed on the skin part 320 depends on skin information.

More particularly, skin information may include control interface information that indicates the display position, display form, function (e.g., play, pause, etc.), input type for manipulation (e.g., click, touch, etc.) and the like of the control interfaces 332, 334, 336 and 338. Normally such control interfaces receive input manipulations for a video control.

Returning again to FIG. 2, the structure analyzer 160 analyzes the structure of flash content in step 220. More particularly, the structure analyzer 160 determines whether flash content contains video information and skin information and, if video and skin information is contained, extracts the video information and skin information. Herein, flash content is exemplarily supposed to contain video information and skin information.

The structure analyzer 160 sends extracted video information to the video display controller 140 in step 230. Video information may be path information about flash video content or flash video content itself. Here, video information is exemplarily supposed to be path information about flash video content. The video display controller 140 sends a video request signal to a video server 205 by using a video plug-in in step 232. Path information about flash video content may contain a sever identifier of the video server 205 storing the flash video content and a content identifier of the flash video content. In step 232, a video request signal may contain a content identifier of requested flashed video content. The video server 205 retrieves flash video content in response to a received video request signal, and sends retrieved content to the video display controller 140 in step 233. Flash video content may adopt the form of f1v, f4v, H.264, AVC (Advanced Video Coding), etc.

The video display controller 140 controls displaying received video content by using a video plug-in in step 235. If received video information indicates a path of flash video content, the video display controller 140 receives and plays video content downloaded through the path by using a video plug-in. If received video information is flash video content itself, the video display controller 140 plays received flash video content by using a video plug-in.

When playing flash video content, a video plug-in selects a codec (not shown) suitable for flash video content by analyzing header information, etc. of flash video content, and outputs video content through the display unit 114 by using the selected codec. Namely, video may be displayed on the video display part 310 shown in FIG. 3 by means of a video plug-in. A codec used for playback of flash video content may be at least one of hardware codec and software codec.

Furthermore, the structure analyzer 160 sends extracted skin information to the skin module 150 in step 240. Skin information is information necessary for displaying a skin and may be a path of a skin image, structure, etc., or such information itself. The skin module 150 displays a skin according to received skin information in step 245. In this step, the skin module 150 may display control interfaces 332, 334, 336 and 338 contained in the skin part 320, as shown in FIG. 3. Also, the skin module 150 may display links, logo image, related video information, and the like.

Meanwhile, while video is being displayed in step 235, the input unit 112 may receive user's instructions to control video (e.g., to play, pause, or stop video, to request a scene change, etc.) through manipulation of the control interfaces 332, 334, 336 and 338 in the skin part 320, or through another manipulation technique. The input unit 112 transforms the received instructions into an input signal and sends it to the signal transmitter 170.

The signal transmitter 170 sends a video control signal to the video display controller 140 in step 260. More specifically, the signal transmitter 170 receives an input signal from the input unit 112 and creates a video control signal corresponding to the received input signal. For instance, an input signal caused by touching or clicking the play button 332 is converted into a video control signal to request playing video. Similarly, an input signal caused by touching or clicking the pause button 334 is converted into a video control signal to request pausing video. Other input signals for controlling video may be converted into a corresponding video control signal.

The video display controller 140 receives a video control signal from the signal transmitter 170 and controls displaying video according to a received video control signal by using a video plug-in in step 270. For instance, if receiving a video control signal to request playing video, the video display controller 140 plays video by using a video plug-in. Similarly, if receiving a video control signal to request pausing video, the video display controller 140 pauses video by using a video plug-in. If receiving another video control signal, the video display controller 140 may control displaying video in response to a received control signal by using a video plug-in. More specifically, a video plug-in may receive a video control signal and then control displaying video in response to a received video control signal.

As discussed heretofore, by displaying a video portion of flash content through a video plug-in, it is possible to play video more effectively than by using a flash plug-in. Additionally, regardless of whether a codec suitable for playing a video is a hardware codec or a software codec, a video plug-in instead of a flash plug-in engages in displaying video, and thereby allows effectively playing video.

The above-described exemplary method according to the present invention can be executed by computer program instructions. Since these program instructions can be included in a general purpose computer, in a special processor or in programmable or dedicated hardware, instructions executed therein may create means for implementing functions discussed above. As would be understood in the art, the computer, the processor or the programmable hardware include memory components that may store or receive software or computer code that when accessed and executed by the computer, processor, or hardware implement the processing methods described herein. In addition, it would be recognized that when a general purpose computer accesses code for implementing the processing shown herein, the execution of the code transforms the general purpose computer into a special purpose computer for executing the processing shown herein. The program instructions and the media may be those specially designed and constructed for the purposes of the present invention, or they may be of a kind known and available to those skilled in the art of computer software.

A mobile device according to an exemplary embodiment of this invention may include, but is not limited to, a variety of portable electronic devices such as a mobile phone, a Personal Digital Assistant (PDA), a smart phone, a Portable Multimedia Player (PMP), a music player, a digital broadcasting receiver, a car navigation system, and the like.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for playing flash-based video, the apparatus comprising:
a structure analyzer for analyzing a structure of flash content and, if there is any video information included in the analyzed flash content, for extracting the video information from the flash content; and
a video display controller for receiving the video information from the structure analyzer and to control displaying video according to the received video information by a video plug-in.

2. The apparatus of claim 1, further comprising:
a skin module,
wherein the structure analyzer is further configured, if there is any skin information including information about a control interface in the analyzed flash content, to extract the skin information from the flash content, and
wherein the skin module is configured to receive the skin information from the structure analyzer and to display a skin according to the received skin information.

3. The apparatus of claim 2, further comprising:
a signal transmitter for receiving an input signal through the control interface, for extracting a video control signal corresponding to the input signal, and for sending the video control signal to the video display controller,
wherein the video display controller is further configured to receive the video control signal from the signal transmitter and to control displaying the video according to the video control signal by using the video plug-in.

4. The apparatus of claim 2, wherein the displayed skin comprises the control interface.

5. The apparatus of claim 1, wherein the video information comprises information of a path of flash video content, and wherein the video display controller is further configured to receive the flash video content through the path and to display the video by using the video plug-in.

6. The apparatus of claim 5, wherein the path information comprises a server identifier and a content identifier.

7. The apparatus of claim 1, wherein the video display controller selects a codec suitable for flash video content.

8. The apparatus of claim 1, wherein the video information comprises flash video content.

9. The apparatus of claim 1, further comprising a mobile web browser.

10. The apparatus of claim 9, wherein the mobile web browser comprises a flash plug-in and the video display controller.

11. A method for playing a flash-based video, the method comprising:
analyzing a structure of flash content;
if there is any video information in the analyzed flash content, extracting the video information from the flash content; and
displaying video according to the video information by using a video plug-in.

12. The method of claim 11, further comprising:
if there is any skin information in the analyzed flash content, extracting the skin information from the flash content; and
displaying a skin according to the skin information,
wherein the skin information includes information about a control interface.

13. The method of claim 12, wherein the displayed skin comprises the control interface.

14. The method of claim 12, further comprising:
receiving an input signal through the control interface and then creating a video control signal corresponding to the input signal; and
controlling displaying the video according to the video control signal by using the video plug-in.

15. The method of claim 11, wherein the video information indicates a path of flash video content, and wherein the displaying of the video includes receiving the flash video content through the path and displaying the video by using the video plug-in.

16. The method of claim 15, wherein the path information comprises a server identifier and a content identifier.

17. The method of claim 11, wherein the displaying of the video comprises selecting a codec suitable for flash video content.

18. The method of claim 11, wherein the video information comprises flash video content.

19. The method of claim 11, wherein the displaying of video is performed by a mobile web browser.

20. The method of claim 19, wherein the mobile web browser comprises a flash plug-in and the video display controller.
